(19) United States
(12) Patent Application Publication
(10) Pub. No.: US 2024/0112055 A1
(43) Pub. Date: Apr. 4, 2024

(54) COMPUTER-READABLE RECORDING MEDIUM STORING NODE ALLOCATION PROGRAM AT THE TIME OF QUANTUM SIMULATION EXECUTION, NODE ALLOCATION METHOD AT THE TIME OF QUANTUM SIMULATION EXECUTION, AND INFORMATION PROCESSING DEVICE

(71) Applicant: Fujitsu Limited, Kawasaki-shi (JP)

(72) Inventor: Hiroki OHTSUJI, Yokohama (JP)

(73) Assignee: Fujitsu Limited, Kawasaki-shi (JP)

(21) Appl. No.: 18/340,922

(22) Filed: Jun. 26, 2023

(30) Foreign Application Priority Data
Sep. 29, 2022 (JP) 2022-156808

(51) Int. Cl. G06N 10/20

(52) U.S. Cl. CPC G06N 10/20

(57) ABSTRACT

A recording medium stores a program for causing a computer to execute processing including: specifying a second quantum circuit of which a feature amount regarding communication is similar to a first quantum circuit used for a first quantum simulation, with reference to a first memory that stores a feature amount regarding communication of a quantum circuit, for each quantum circuit for a quantum simulation; calculating a predicted execution time of the first quantum simulation when the number of nodes are allocated for each of numbers of nodes, with reference to a second memory that stores a measured execution time for each number of nodes allocated to a quantum simulation in the past by using the specified second quantum circuit; and determining the number of nodes to be allocated to the first quantum simulation, from among the numbers of nodes, based on the calculated predicted execution time.

### CROSS-REFERENCE TO RELATED APPLICATION

This application is based upon and claims the benefit of priority of the prior Japanese Patent Application No. 2022-156808, filed on Sep. 29, 2022, the entire contents of which are incorporated herein by reference.

### FIELD

The embodiment discussed herein is related to a node allocation program at the time of quantum simulation execution, a node allocation method at the time of quantum simulation execution, and an information processing device.

### BACKGROUND

In recent years, in preparation for appearance of quantum computers, simulations have been performed on a typical computer, and techniques for quantum calculation have been developed. The quantum simulation is a technique that performs quantum calculation by reproducing a quantum state on a normal computer and calculating quantum bit interaction or the like (state-vector method).

Japanese Laid-open Patent Publication No. 2013-140490 is disclosed as related art.

### SUMMARY

According to an aspect of the embodiments, a non-transitory computer-readable recording medium stores a node allocation program at the time of quantum simulation execution for causing a computer to execute processing including: specifying a second quantum circuit of which a feature amount regarding communication is similar to a first quantum circuit used for a first quantum simulation, with reference to a first memory that stores a feature amount regarding communication of a quantum circuit, for each quantum circuit used for a quantum simulation; calculating a predicted execution time of the first quantum simulation in a case where the number of nodes are allocated for each of a plurality of numbers of nodes, with reference to a second memory that stores a measured execution time for each number of nodes allocated to a quantum simulation in the past by using the specified second quantum circuit; and determining the number of nodes to be allocated to the first quantum simulation, from among the plurality of numbers of nodes, based on the calculated predicted execution time, according to an allocation status of a quantum simulation for a node group that is usable for the first quantum simulation.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram illustrating an example of a node allocation method at the time of quantum simulation execution;

FIG. 2 is an explanatory diagram illustrating a scale-out example of a quantum simulation;

FIG. 3 is an explanatory diagram illustrating a system configuration example of a scheduling system 300;

FIG. 4 is a block diagram illustrating a hardware configuration example of a scheduling device 301;

FIG. 5 is an explanatory diagram illustrating an example of content stored in an execution time recording table 320;

FIG. 6 is an explanatory diagram illustrating an example of content stored in a circuit feature amount table 330;

FIG. 7 is a block diagram illustrating a functional configuration example of the scheduling device 301;

FIG. 8A is an explanatory diagram (part 1) illustrating an example of content stored in a prediction execution time table 800;

FIG. 8B is an explanatory diagram (part 2) illustrating an example of the content stored in the prediction execution time table 800;

FIG. 9 is a flowchart (part 1) illustrating an example of a node allocation processing procedure at the time when the scheduling device 301 executes a quantum simulation; and

FIG. 10 is a flowchart (part 2) illustrating an example of the node allocation processing procedure at the time when the scheduling device 301 executes the quantum simulation.

### DESCRIPTION OF EMBODIMENTS

As a related art, for example, there is a technique for executing a program to be executed through parallel calculation using a plurality of nodes, with a plurality of jobs, analyzing a calculation result of each job at each regular elapsed time, and adjusting a degree of parallelism of each job so that ends of all jobs become the same based on a remaining execution time of each job obtained from the analysis result.

However, with the related art, it is difficult to efficiently use a computer group when a plurality of quantum simulations is performed, with the computer (node) group shared by a plurality of users.

In one aspect, an object of the embodiment is to improve a utilization efficiency of a node group at the time of quantum simulation execution.

Hereinafter, embodiments of a node allocation program at the time of quantum simulation execution, a node allocation method at the time of the quantum simulation execution, an information processing device according to the embodiment will be described in detail with reference to the drawings.

### EMBODIMENTS

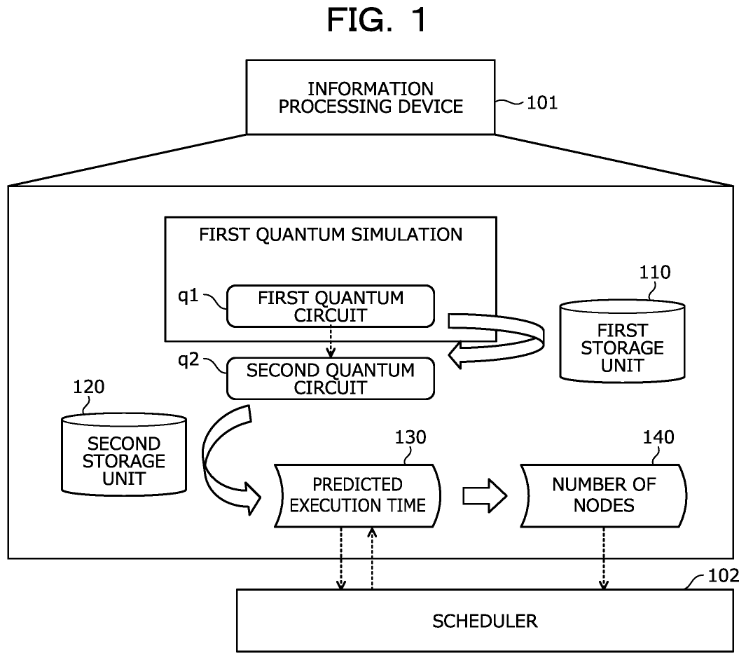

FIG. 1 is an explanatory diagram illustrating an example of a node allocation method at the time of quantum simulation execution. In FIG. 1, an information processing device 101 is a computer that determines the number of nodes to be allocated to a quantum simulation. The node is a normal computer (computer), a so-called classical computer.

The quantum simulation simulates quantum calculation by holding a state of a quantum bit by on a memory of the computer (classical computer). In the quantum simulation, when the number of quantum bits to be simulated is incremented by one, a required memory amount is doubled. Therefore, in a case where the number of required quantum bits is large, the quantum simulation is performed while a plurality of computers is operated in parallel. The number of required quantum bits varies, for example, depending on applications.

Furthermore, a computer group that performs the quantum simulation is often shared by a plurality of users. In a system in which the computer group is shared by the plurality of users, a necessary number of computers are allocated of each user for a necessary time. Furthermore, a situation in which many computers as possible are operated is desirable in terms of utilization efficiency of a facility.

Typically, for example, a job scheduler shared by a plurality of users is included in a massively parallel computer such as a supercomputer. In a case of using a computer, the user inputs a “job” describing an operation of a series of programs. The job is loaded into a queue, and is executed as soon as the computer is available. The number of occupied nodes and an expected processing time are set to the job.

The quantum simulation is a program that actually operates on the parallel computer. Therefore, an existing scheduler may be used for scheduling of the quantum simulation. For example, the existing scheduler performs scheduling in a the first in first out (FIFO) method for executing input jobs in an input order.

Furthermore, the existing scheduler has a function called back fill for executing a job that is input later before a job that is input earlier. In the back fill, only in a case where a job with a lower priority does not interfere with a job with a higher priority, the job with the lower priority is executed before the job with the higher priority.

For example, when the jobs are executed in the input order (in depending order of priority), there may be a case where not all the computer group can be used depending on the number of occupied nodes of the job, and some of computers are in a standby (free) state. Such a time when some computers are in the standby state is referred to as a gap time. According to the back fill, when it is determined that the job can be executed in a current gap time based on a predicted completion time (expected processing time) of the job, the job can be inserted into the gap time and be processed.

Note that, in a case where the processing does not end before the predicted completion time, the processing is forced to terminate. Therefore, in a case where prediction accuracy is low, for example, the predicted completion time is set to be longer. On the other hand, if the predicted completion time increases, the back fill is less likely to be performed. Therefore, the predicted completion time should not be made unnecessarily longer.

It can be said that the back fill is an effective function to improve utilization efficiency of the computer group. However, large-scale use of the quantum simulation more easily occurs, as compared with a normal supercomputer or the like, depending on applications. The large-scale use is, for example, to perform the quantum simulation using all of the computer group (overall use).

Therefore, the quantum simulation tends to have a restriction on the gap time in which back fill can be performed. Therefore, the existing scheduler does not effectively perform back fill when performing a plurality of quantum simulations, and it is difficult to improve the utilization efficiency of the computer group at the time of quantum simulation execution.

Here, in a parallel application, scalability varies depending on processing content. The scalability is, for example, an improvement degree of a performance when the number of computers to be used is increased. For example, in a case where performance increases eightfold at the time when 10 times of computers are used, it can be said that the scalability is 80%.

In the quantum simulation, interaction calculation in a quantum circuit is performed, and a communication pattern or the like is determined according to a defined circuit. Therefore, the quantum simulation can easily predict the scalability than a normal application.

For example, regarding the normal application, when the number of computers is changed, for example, a boundary for dividing a problem (calculation) changes, and it tends to be difficult to read characteristics. On the other hand, since the quantum simulation depends on a given quantum circuit, not an input change or the like, the quantum simulation easily predict the scalability for each quantum circuit.

Therefore, in the present embodiment, a node allocation method for improving utilization efficiency of a node group at the time of quantum simulation execution will be described, by using that scalability in parallel execution of a quantum simulation depends on a configuration of a quantum circuit. Here, a processing example of the information processing device 101 will be described.

(1) The information processing device 101 specifies a second quantum circuit of which a feature amount regarding communication is similar to a first quantum circuit used for a first quantum simulation, with reference to a first storage unit 110. Here, the first storage unit 110 stores a feature amount regarding communication of a quantum circuit, for each quantum circuit used for a quantum simulation.

The first quantum simulation is a quantum simulation to be executed, and for example, is a quantum simulation requested to be executed by a user. The quantum circuit is a calculation model used to perform quantum calculation. The quantum circuit is determined based on what type of processing (for example, to obtained energy of certain molecule) is executed in the quantum simulation.

Since the communication pattern or the like is determined according to the quantum circuit, the quantum simulation easily predicts a change degree of a performance in a case where the number of nodes to be used is increased or decreased. Furthermore, it can be said that a quantum circuit of which a communication pattern or the like is similar to a certain quantum circuit has a similar scalability to a quantum simulation using the certain quantum circuit.

Therefore, for example, the information processing device 101 specifies the second quantum circuit of which the feature amount regarding the communication is similar to the first quantum circuit, among quantum circuits having known scalability, with reference to the first storage unit 110. Note that the feature amount regarding the communication of the first quantum circuit may be stored in the first storage unit 110 or may be extracted from the first quantum circuit (calculation model), for example.

The feature amount is an index value representing a feature regarding communication of a quantum circuit. For example, depending on the communication pattern, a communication amount between nodes required to execute the quantum simulation tends to change. Therefore, if the communication amounts between the nodes required for execution of two quantum simulations are similar, it can be said that the communication patterns are similar.

Therefore, the feature amount may represent the communication amount (size thereof) between the nodes required to execute the quantum simulation. For example, the feature amount may be a communication amount between nodes in a case where a quantum simulation is performed with a specific number of nodes. Furthermore, the feature amount may be a communication amount between nodes in a case where the quantum simulation is performed with each of a plurality of numbers of nodes, for each of the plurality of numbers of nodes. Furthermore, the feature amount may be an average value of the communication amount between the nodes in a case where the quantum simulation is performed with each of the plurality of numbers of nodes. Note that the feature amount can be extracted by analyzing content of the quantum circuit (calculation model), without actually performing the quantum simulation.

In the example in FIG. 1, a case is assumed where a second quantum circuit q2 of which a feature amount regarding communication is similar to a first quantum circuit q1 used for the first quantum simulation is specified.

(2) The information processing device 101 calculates a predicted execution time of the first quantum simulation in a case where the number of nodes are allocated, for each of the plurality of numbers of nodes, with reference to a second storage unit 120. Here, the plurality of numbers of nodes is arbitrarily set according to the number of nodes (the maximum number of nodes) of a node group that can be used for the first quantum simulation.

For example, when it is assumed that the maximum number of nodes be “5”, the plurality of numbers of nodes may be “1, 2, 3, 4, 5”. Furthermore, when it is assumed that the maximum number of nodes be “10”, the plurality of numbers of nodes may be “1, 2, 4, 6, 8, 10”. Furthermore, when it is assumed that the maximum number of nodes be “32”, the plurality of numbers of nodes may be “1, 2, 4, 8, 16, 32”.

Furthermore, the second storage unit 120 stores a measured execution time for each number of nodes allocated to a second quantum simulation using the second quantum circuit. The measured execution time is an execution time measured in a case where a certain number of nodes are allocated to the second quantum simulation and the second quantum simulation is performed. The second storage unit 120 stores two or more pairs of the number of nodes and the measured execution time.

A predicted execution time of the first quantum simulation is calculated, for example, with linear approximation or curve approximation based on the measured execution time. Here, it is assumed that the plurality of numbers of nodes be “1, 2, 4, 8, 16, 32”. Furthermore, it is assumed that a measured execution time when two nodes are allocated to the second quantum simulation and a measured execution time when eight nodes are allocated to the second quantum simulation be stored in the second storage unit 120.

In this case, the information processing device 101 calculates a predicted execution time of the first quantum simulation in a case where each of the numbers of nodes “1, 2, 4, 8, 16, 32” is allocated, with the linear approximation or the curve approximation, from the measured execution time of the number of nodes “2” and the measured execution time of the number of nodes “8”.

In the example in FIG. 1, a case is assumed where a predicted execution time 130 is calculated. The predicted execution time 130 indicates a predicted execution time of the first quantum simulation in a case where each of the numbers of nodes “1, 2, 4, 8, 16, 32” is allocated.

(3) The information processing device 101 determines the number of nodes to be allocated to the first quantum simulation, from among the plurality of numbers of nodes, based on the calculated predicted execution time, according to an allocation status of the quantum simulation in the node group. At this time, for example, the information processing device 101 determines the number of nodes to be allocated to the first quantum simulation, so that an execution start time of the first quantum simulation becomes earlier.

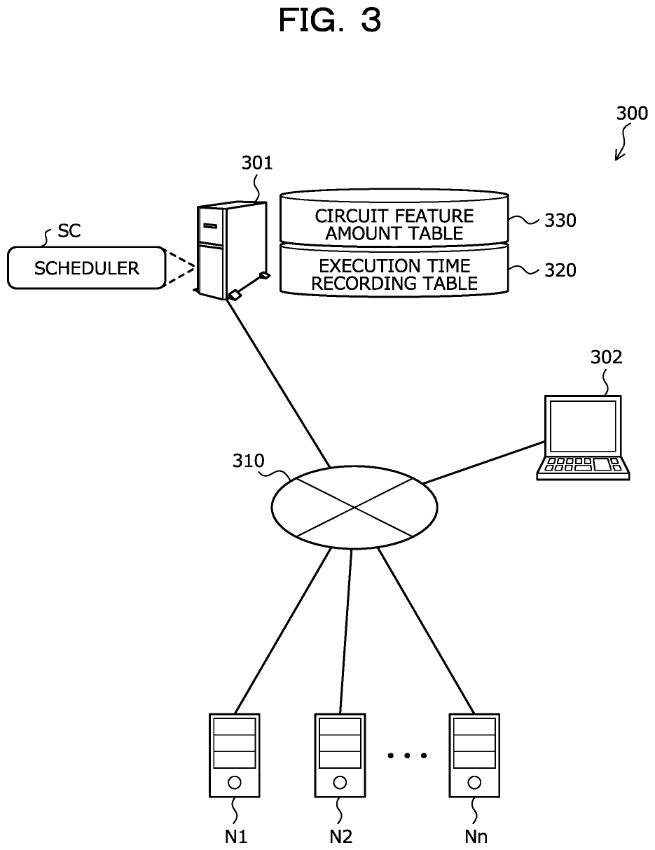

Here, the node group is a computer group (for example, nodes N1 to Nn illustrated in FIG. 3) that can be used for the first quantum simulation. Furthermore, the execution start time of the first quantum simulation is a scheduled time when the execution of the first quantum simulation is started. The execution start time of the first quantum simulation changes according to an allocation status of another quantum simulation (job) in the node group.

For example, a gap time may be generated, depending on the allocation status of the another quantum simulation. In a case where the first quantum simulation is performed within the gap time, the back fill is performed, and the execution start time becomes earlier than a case where the first quantum simulation is not performed within the gap time. However, depending on the number of nodes to be allocated to the first quantum simulation and the predicted execution time, there is a case where the first quantum simulation is performed within the gap time and is not performed within the gap time.

Therefore, for example, the information processing device 101 notifies a scheduler 102 of a pair of the number of nodes to be allocated to the first quantum simulation and the predicted execution time and inquires the execution start time of the first quantum simulation. The scheduler 102 schedules the quantum simulation, according to a use state of the node group.

For example, the scheduler 102 has a function similar to an existing job scheduler. For example, the scheduler 102 performs scheduling in the FIFO method for performing input quantum simulations (job) in an input order. Furthermore, the scheduler 102 has a back fill function.

For example, the information processing device 101 notifies the scheduler 102 of the pair of the number of nodes and the predicted execution time, for each of the plurality of numbers of nodes “1, 2, 4, 8, 16, 32”, with reference to the predicted execution time 130. As a result, the information processing device 101 inquires the execution start time of the first quantum simulation according to the allocation status of the quantum simulation in the node group, for each pair of the number of nodes and the predicted execution time. Then, the information processing device 101 may determine the number of nodes with which the execution start time of the first quantum simulation becomes the earliest, from among the plurality of numbers of nodes “1, 2, 4, 8, 16, 32” as the number of nodes to be allocated to the first quantum simulation.

In the example in FIG. 1, a case is assumed where the number of nodes “16” with which the execution start time of the first quantum simulation becomes the earliest, from among the plurality of numbers of nodes “1, 2, 4, 8, 16, 32”, as the number of nodes to be allocated to the first quantum simulation. In this case, the information processing device 101 allocates the determined number “16” of nodes and makes the nodes perform the first quantum simulation.

For example, the information processing device 101 instructs the scheduler 102 to use the determined number “16” of nodes and inputs the first quantum simulation (job). For example, it is assumed that the number of nodes designated in a request to perform the first quantum simulation be “4”. In this case, the number of nodes to be used for the first quantum simulation is scaled out from “4” to “16”, and the first quantum simulation is performed.

Note that the scheduler 102 may be implemented by the information processing device 101 or may be implemented by another computer different from the information processing device 101.

In this way, according to the information processing device 101, it is possible to predict the scalability characteristics of the first quantum simulation (predicted execution time for each of the plurality of numbers of nodes), using that the scalability in parallel execution of the quantum simulation depends on the configuration of the quantum circuit. Furthermore, even in a case where there is no record of the quantum simulation using the first quantum circuit, the information processing device 101 can predict the scalability characteristics of the first quantum simulation, using the record of the quantum simulation using the second quantum circuit having the scalability characteristics similar to the first quantum circuit.

Furthermore, according to the information processing device 101, it is possible to determine the number of nodes to be allocated to the first quantum simulation so that the execution start time of the first quantum simulation becomes earlier, based on the predicted scalability characteristics. As a result, the information processing device 101 can increase a back fill rate and can improve the utilization efficiency of the node group at the time of quantum simulation execution.

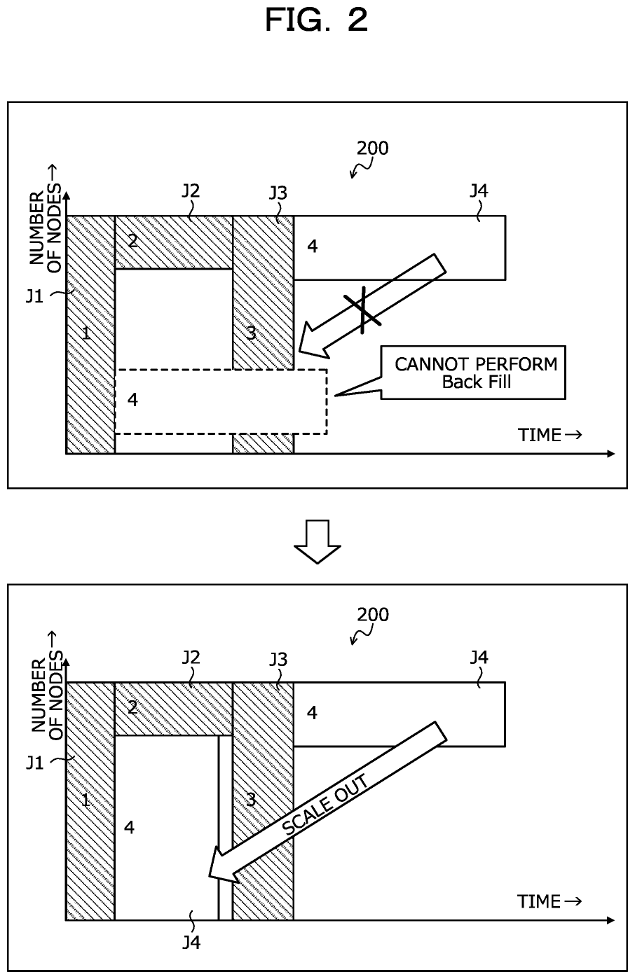

Here, a scale-out example of the quantum simulation will be described with reference to FIG. 2.

FIG. 2 is an explanatory diagram illustrating the scale-out example of the quantum simulation. In FIG. 2, a graph 200 illustrates another quantum simulation (job) allocation status of the node group that can be allocated to the first quantum simulation. The vertical axis indicates the number of nodes. The horizontal axis indicates passage of time.

Here, the first quantum simulation is expressed as a “job J4”. Jobs J1 to J3 respectively express other quantum simulations different from the first quantum simulation. In FIG. 2, a number in each of the jobs J1 to J4 indicates an input order. The higher the input order, the higher the priority.

Here, it is assumed that the job J1 be executed using 10 nodes (overall use). It is assumed that the job J2 be executed using two nodes. It is assumed that the job J3 be executed using 10 nodes (overall use). As a result, a gap time 210 is generated between a time t1 and a time t2.

The gap time 210 indicates that eight nodes are in a free state for 100 seconds. The size of the gap time 210 is “the number of nodes 8×100 seconds”. Here, it is assumed that the number of nodes “3” be designated in a request to execute the job J4 (first quantum simulation). The number of nodes “3” is the minimum number of nodes required to execute the job J4, for example, which is determined based on a memory usage amount.

Furthermore, a predicted execution time of the job J4 when the number of nodes is “3” is set to “150 seconds”. In this case, the job J4 is not executed within the gap time 210. Therefore, the existing scheduler does not perform back fill, and for example, an execution start time of the job J4 is a time t3 when execution of the job J3 is completed.

On the other hand, when executing the job J4 (first quantum simulation), the information processing device 101 calculates a predicted execution time of the job J4 for each number of nodes. Then, the information processing device 101 determines the number of nodes to be allocated to the job J4, so that the execution start time of the job J4 becomes earlier, based on the calculated predicted execution time.

Here, the predicted execution time of the job J4 when the number of nodes is eight is set to “90 seconds”. In this case, by scaling out the number of nodes to be used for the job J4 from “3” to “8”, the predicted execution time is shortened from “150 seconds” to “90 seconds” (aspect ratio is changed), and the job J4 is executed within the gap time 210.

Therefore, the execution start time t1 when the number of nodes is “8” and the predicted execution time is “90 seconds” is obtained from the scheduler 102. The execution start time t1 is earlier than the execution start time t3 of the job J4 when the number of nodes is “3”.

The information processing device 101 determines the number of nodes “8” as the number of nodes to be allocated to the job J4. As a result, for example, when the information processing device 101 instructs the scheduler 102 to use the number of nodes “8” and inputs the job J4, the back fill is performed, and the job J4 overtakes the job J3 and is executed.

(System Configuration Example of Scheduling System 300)

Next, a system configuration example of the scheduling system 300 including the information processing device 101 illustrated in FIG. 1 will be described. Here, a case where the information processing device 101 illustrated in FIG. 1 is applied to a scheduling device 301 in the scheduling system 300 will be described as an example. The scheduling system 300 is applied to, for example, a supercomputer that performs a quantum simulation.

FIG. 3 is an explanatory diagram illustrating the system configuration example of the scheduling system 300. In FIG. 3, the scheduling system 300 includes the scheduling device 301, a client device 302, and a group of nodes N1 to Nn (n: natural number of two or more). In the scheduling system 300, the scheduling device 301, the client device 302, and the group of nodes N1 to Nn are coupled via wired or wireless network 310. The network 310 is, for example, the Internet, a local area network (LAN), a wide area network (WAN), or the like.

In the following description, an arbitrary node in the group of nodes N1 to Nn may be expressed as a “node Ni” (i=1, 2, . . . , n).

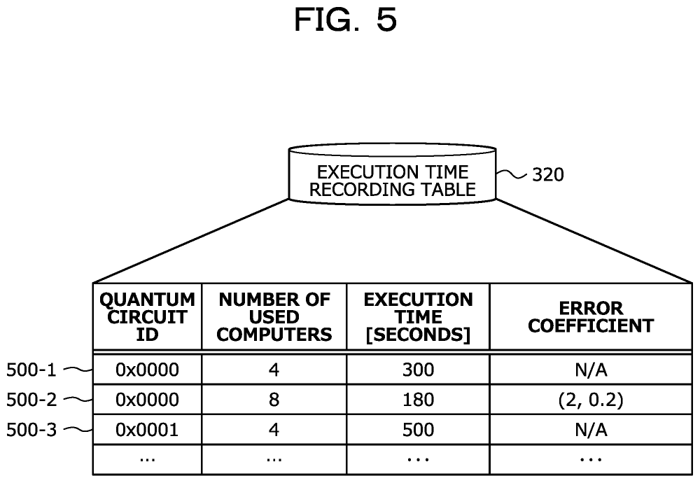

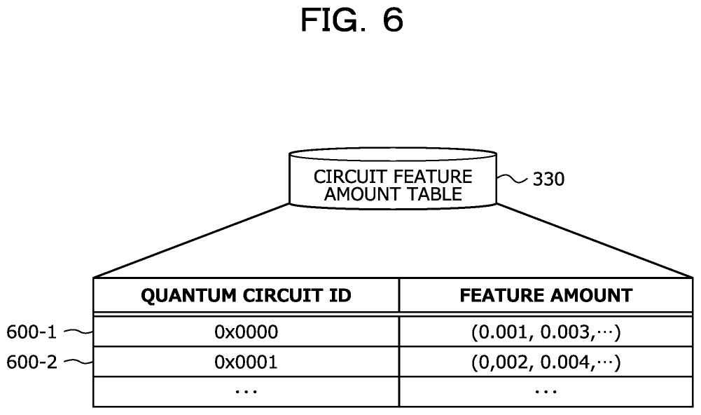

Here, the scheduling device 301 is a computer that includes an execution time recording table 320 and a circuit feature amount table 330 and determines the number of nodes to be allocated to the quantum simulation. Content stored in the execution time recording table 320 and the circuit feature amount table 330 will be described later with reference to FIGS. 5 and 6.

Furthermore, the scheduling device 301 includes a scheduler SC. The scheduler SC is software that performs scheduling of the quantum simulation. For example, the scheduler SC performs scheduling in the FIFO method for performing the input quantum simulations (job) in input order. Furthermore, the scheduler SC has a back fill function. The scheduler 102 illustrated in FIG. 1 corresponds to, for example, the scheduler SC. The scheduling device 301 is, for example, a server.

The client device 302 is a computer used by a user of the scheduling system 300. For example, the user accesses the scheduling device 301 from the client device 302 and requests to perform the quantum simulation (job) or the like. The client device 302 is, for example, a personal computer (PC), a tablet PC, or the like.

The group of nodes N1 to Nn is a computer to be an allocation destination of the quantum simulation. The performance of each node of the group of nodes N1 to Nn is, for example, the same. Each of the nodes N1 to Nn is, for example, a server.

Note that, here, the scheduling device 301 includes the scheduler SC. However, the embodiment is not limited to this. For example, the scheduler SC may be included in another computer that can be coupled to the scheduling device 301 via the network 310. Furthermore, the scheduling device 301 may be implemented by the client device 302. Furthermore, the plurality of client devices 302 may be included in the scheduling system 300.

(Hardware Configuration Example of Scheduling Device 301)

Next, a hardware configuration example of the scheduling device 301 will be described.

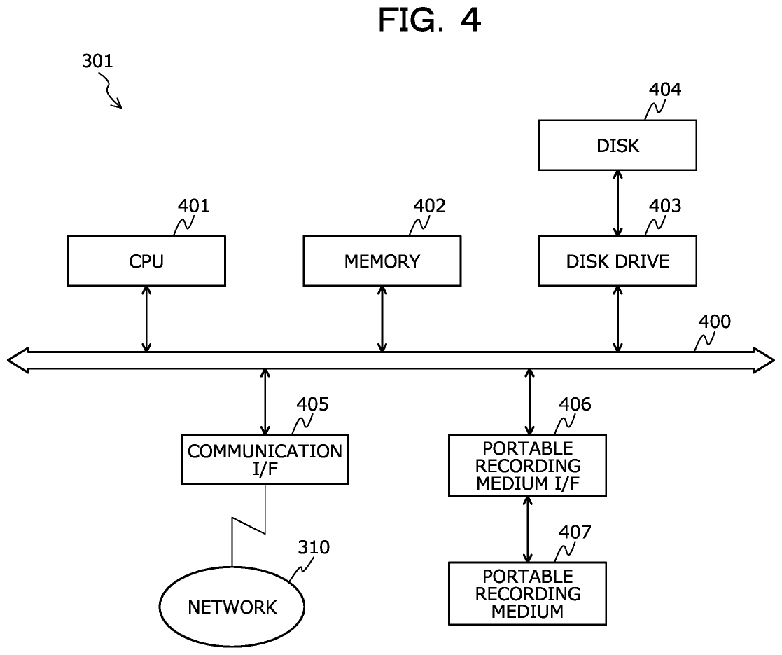

FIG. 4 is a block diagram illustrating the hardware configuration example of the scheduling device 301. In FIG. 4, the scheduling device 301 includes a central processing unit (CPU) 401, a memory 402, a disk drive 403, a disk 404, a communication interface (I/F) 405, a portable recording medium I/F 406, and a portable recording medium 407. In addition, the individual components are coupled to each other by a bus 400.

Here, the CPU 401 performs overall control of the scheduling device 301. The CPU 401 may include a plurality of cores. For example, the memory 402 includes a read only memory (ROM), a random access memory (RAM), a flash ROM, or the like. For example, the flash ROM stores an OS program, the ROM stores application programs, and the RAM is used as a work area for the CPU 401. The programs stored in the memory 402 are loaded into the CPU 401 to cause the CPU 401 to execute coded processes.

The disk drive 403 controls reading/writing of data from/to the disk 404 under the control of the CPU 401. The disk 404 stores data written under the control of the disk drive 403. As examples of the disk 404, a magnetic disk, an optical disc, and the like are exemplified.

The communication I/F 405 is coupled to the network 310 via a communication line and is coupled to an external computer (for example, client device 302 and group of nodes N1 to Nn illustrated in FIG. 3) via the network 310. Then, the communication I/F 405 manages an interface between the network 310 and the inside of the device, and controls input and output of data from the external computer. For example, a modem, a LAN adapter, or the like may be adopted as the communication I/F 405.

The portable recording medium I/F 406 controls reading/writing of data from/to the portable recording medium 407 under the control of the CPU 401. The portable recording medium 407 stores data written under the control of the portable recording medium I/F 406. As the portable recording medium 407, for example, a compact disc (CD)-ROM, a digital versatile disk (DVD), a universal serial bus (USB) memory, and the like are exemplified.

Note that the scheduling device 301 may include, for example, an input device, a display, or the like, in addition to the components described above. Furthermore, the scheduling device 301 does not need to include, for example, the portable recording medium I/F 406 and the portable recording medium 407, among the components described above. Furthermore, the client device 302 and the group of nodes N1 to Nn illustrated in FIG. 3 can be implemented by the hardware configuration similar to the scheduling device 301. Note that the client device 302 includes, for example, an input device, a display, or the like in addition to the components described above.

(Content Stored in Execution Time Recording Table 320 And Circuit Feature Amount Table 330)

Next, content stored in the execution time recording table 320 and the circuit feature amount table 330 included in the scheduling device 301 will be described with reference to FIGS. 5 and 6. The execution time recording table 320 and the circuit feature amount table 330 are implemented by a storage device such as the memory 402 or the disk 404 illustrated in FIG. 4, for example.

FIG. 5 is an explanatory diagram illustrating an example of the content stored in the execution time recording table 320. In FIG. 5, the execution time recording table 320 includes fields of a quantum circuit ID, the number of used computers, an execution time, and an error coefficient, and stores execution time information (for example, execution time information 500-1 to 500-3) as a record by setting information in each field.

Here, the quantum circuit ID is an identifier used to uniquely identify a quantum circuit used for a quantum simulation. The number of used computers is the number of nodes (computers) used for the quantum simulation. The execution time is a time (measured value) taken to perform the quantum simulation (unit: [second]).

The error coefficient is a coefficient used when the predicted execution time is corrected. The error coefficient includes a predicted error amount and a measured processing time error. The predicted error amount represents a ratio between the number of nodes (the number of computers) designated when the quantum simulation (job) is input and the number of measured computers. The measured processing time error represents an error between the predicted execution time and the measured execution time. N/A indicates not applicable.

FIG. 6 is an explanatory diagram illustrating an example of the content stored in the circuit feature amount table 330. In FIG. 6, the circuit feature amount table 330 includes fields of a quantum circuit ID and a feature amount and stores circuit feature amount information (for example, circuit feature amount information 600-1 and 600-2) as a record by setting information in each field.

Here, the quantum circuit ID is an identifier used to uniquely identify a quantum circuit used for a quantum simulation. The feature amount is a feature amount regarding communication of a quantum circuit. The feature amount is expressed by one or a plurality of elements. For example, the element is a value representing a communication amount (size thereof) between the nodes required to perform the quantum simulation using the quantum circuit.

Furthermore, the element may be a value representing a dependency degree between processing executed in the quantum simulation, for example, a dependency degree between processes executed by the respective nodes. Note that, a dependency relationship between the processing is a relationship such that, when one node does not receive a processing result of another node, the node cannot proceed to the next processing.

(Functional Configuration Example of Scheduling Device 301)

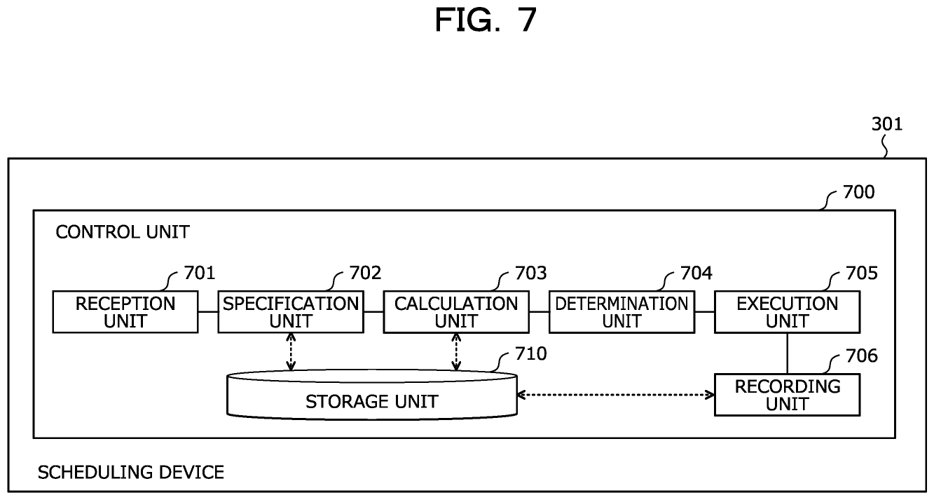

FIG. 7 is a block diagram illustrating a functional configuration example of the scheduling device 301. In FIG. 7, the scheduling device 301 includes a reception unit 701, a specification unit 702, a calculation unit 703, a determination unit 704, an execution unit 705, a recording unit 706, and a storage unit 710. The reception unit 701 to the recording unit 706 have functions serving as a control unit, and, for example, those functions are implemented by causing the CPU 401 to execute the program stored in a storage device such as the memory 402, the disk 404, or the portable recording medium 407 illustrated in FIG. 4, or by the communication I/F 405. A processing result of each functional unit is stored in, for example, the storage device such as the memory 402 or the disk 404. Furthermore, the storage unit 710 is implemented by the storage device such as the memory 402 or the disk 404. For example, the storage unit 710 stores the execution time recording table 320 illustrated in FIG. 5 and the circuit feature amount table 330 illustrated in FIG. 6.

The reception unit 701 receives a quantum simulation request. Here, the quantum simulation request is a request to perform a quantum simulation. The quantum simulation request includes, for example, a quantum circuit ID and the designated number of nodes. The quantum circuit ID is an identifier used to uniquely identify a quantum circuit used for a quantum simulation.

The designated number of nodes is the number of nodes to be allocated to the quantum simulation, designated by a user. The designated number of nodes is designated, for example, according to a memory amount required for the quantum simulation. Note that a designated predicted execution time may be included in the quantum simulation request. The designated predicted execution time is a predicted execution time required to perform the quantum simulation, designated by the user.

For example, the reception unit 701 receives the quantum simulation request by receiving the quantum simulation request from the client device 302 illustrated in FIG. 3. Furthermore, the reception unit 701 may receive the quantum simulation request through a user's operation input using an input device (not illustrated).

In the following description, there is a case where a quantum simulation (first quantum simulation) of which execution is requested by the quantum simulation request is referred to as a “quantum simulation to be executed”. Furthermore, there is a case where a quantum circuit used for the quantum simulation to be executed is referred to as a “first quantum circuit”.

The specification unit 702 specifies the second quantum circuit of which the feature amount regarding communication is similar to the first quantum circuit used for the quantum simulation to be executed, with reference to the storage unit 710. The storage unit 710 stores the feature amount regarding the communication of the quantum circuit, for each quantum circuit used for the quantum simulation.

The feature amount includes, for example, an index value representing a communication amount (size thereof) between nodes required to perform a quantum simulation. Furthermore, the feature amount may represent a dependency degree between processing executed by the respective nodes in the quantum simulation. The feature amount can be extracted by analyzing content of the quantum circuit (calculation model), for example.

For example, the specification unit 702 calculates an error of a feature amount regarding communication between the first quantum circuit and another quantum circuit, with reference to the circuit feature amount table 330 illustrated in FIG. 5. The error of the feature amount can be represented by a distance between the feature amounts (Euclidean distance, cosine similarity, or the like), for example.

The feature amount regarding the communication of the first quantum circuit may be stored, for example, in the circuit feature amount table 330. Furthermore, the feature amount regarding the communication of the first quantum circuit may be extracted by analyzing the content of the first quantum circuit by the specification unit 702. The circuit feature amount table 330 is an example of the first storage unit 110 illustrated in FIG. 1.

For example, the specification unit 702 compares the feature amount regarding the communication of the first quantum circuit with a feature amount regarding communication of another quantum circuit in the circuit feature amount table 330 and calculates a distance between the feature amounts. Then, the specification unit 702 specifies the another quantum circuit of which the calculated distance is the shortest (quantum circuit with highest similarity) as the second quantum circuit. Furthermore, the specification unit 702 may specify another quantum circuit of which the calculated distance is equal to or shorter than a threshold as the second quantum circuit.

The calculation unit 703 calculates a predicted execution time of the quantum simulation to be executed in a case where the number of nodes are allocated, for each of the plurality of numbers of nodes, with reference to the storage unit 710. The storage unit 710 stores the measured execution time for each number of nodes allocated to the quantum simulation in the past using the second quantum circuit.

The plurality of numbers of nodes is arbitrarily set according to the maximum number of nodes that can be allocated to the quantum simulation to be executed. The maximum number of nodes that can be allocated corresponds to the numbers of nodes of the group of nodes N1 to Nn illustrated in FIG. 2, for example. For example, if “n=32”, the plurality of numbers of nodes may be “1, 2, 4, 8, 16, 32”.

In the following description, the plurality of numbers of nodes is referred to as “the numbers of nodes #1 to #m”, and any one of the numbers of nodes among the numbers of nodes #1 to #m may be referred to as the “number of nodes #i” (i=1, 2, . . . , m).

For example, the calculation unit 703 acquires execution time information corresponding to a quantum circuit ID of the specified second quantum circuit, from the execution time recording table 320 illustrated in FIG. 5. At this time, the calculation unit 703 acquires two or more pieces of execution time information corresponding to the quantum circuit ID of the second quantum circuit.

The number of used computers and an execution time indicated by the acquired execution time information indicate the measured execution time for each number of nodes allocated to the quantum simulation in the past using the second quantum circuit. For example, the execution time information 500-1 (refer to FIG. 5) indicates a measured execution time “300 [seconds])” when four nodes are allocated to a quantum simulation using a quantum circuit with a quantum circuit ID “0x0000”. The execution time recording table 320 is an example of the second storage unit 120 illustrated in FIG. 1.

Then, the calculation unit 703 calculates a predicted execution time of the quantum simulation to be executed in a case where each number of nodes #i are allocated, for each number of nodes #i of the numbers of nodes #1 to #m, based on the number of used computers and the execution time of each piece of the acquired execution time information. The predicted execution time of the quantum simulation to be executed is calculated, for example, with existing linear approximation or curve approximation.

Furthermore, the specification unit 702 determines whether or not the measured execution time for each number of nodes allocated to the quantum simulation in the past using the first quantum circuit is stored in the storage unit 710. For example, the specification unit 702 searches for the execution time information corresponding to a quantum circuit ID of the first quantum circuit, from the execution time recording table 320. The quantum circuit ID of the first quantum circuit is included in the quantum simulation request, for example.

Here, in a case where two or more pieces of execution time information are searched, the specification unit 702 determines that the measured execution time for each number of nodes allocated to the quantum simulation in the past is stored. On the other hand, in a case where two or more pieces of execution time information are not searched, the specification unit 702 determines that the measured execution time for each number of nodes allocated to the quantum simulation in the past is not stored.

Then, in a case where the measured execution time for each number of nodes allocated to the quantum simulation in the past is not stored, the specification unit 702 may specify the second quantum circuit of which the feature amount regarding the communication is similar to the first quantum circuit used for the quantum simulation to be executed.

As a result, in a case where there is no record of the quantum simulation in the past using the quantum circuit (first quantum circuit) same as the quantum simulation to be executed, the scheduling device 301 can calculate the predicted execution time of the quantum simulation to be executed, using a record of the quantum simulation using the second quantum circuit of which the feature amount is similar to the first quantum circuit.

Furthermore, in a case where the measured execution time for each number of nodes allocated to the quantum simulation in the past using the first quantum circuit is stored, the calculation unit 703 may calculate a predicted execution time of the quantum simulation to be executed in a case where each number of nodes #i are allocated, for each number of nodes #i, based on the measured execution time for each number of nodes stored in the storage unit 710.

For example, the calculation unit 703 acquires the execution time information corresponding to the quantum circuit ID of the first quantum circuit, from the execution time recording table 320. At this time, the calculation unit 703 acquires two or more pieces of execution time information corresponding to the quantum circuit ID of the first quantum circuit. The number of used computers and an execution time indicated by the acquired execution time information indicate the measured execution time for each number of nodes allocated to the quantum simulation in the past using the first quantum circuit.

Then, the calculation unit 703 calculates a predicted execution time of the quantum simulation to be executed in a case where each number of nodes #i are allocated, for each number of nodes #i, based on the number of used computers and the execution time of each piece of the acquired execution time information.

As a result, in a case where there is the record of the quantum simulation in the past using the quantum circuit (first quantum circuit) same as the quantum simulation to be executed, the scheduling device 301 can calculate the predicted execution time of the quantum simulation to be executed using the record.

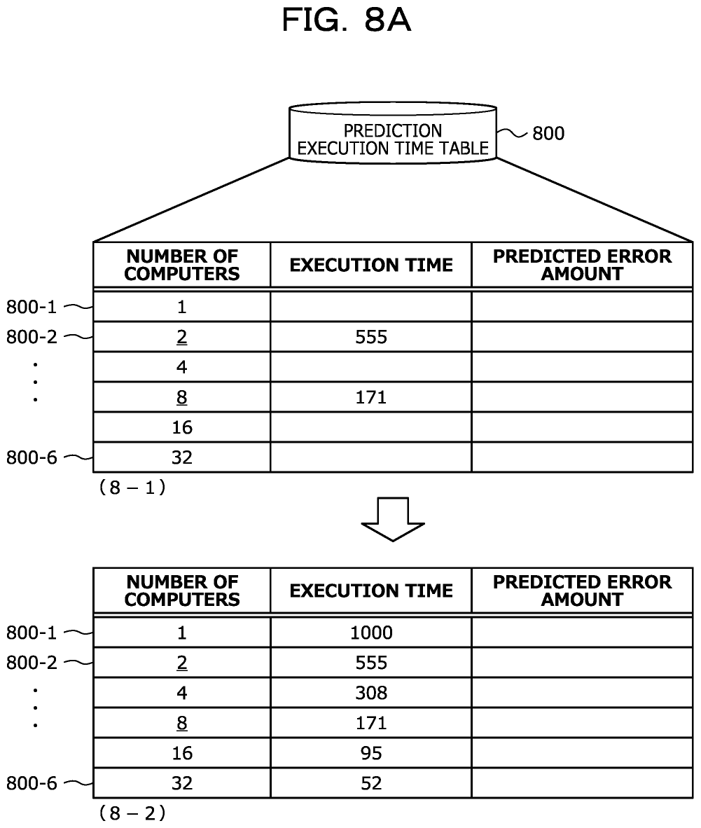

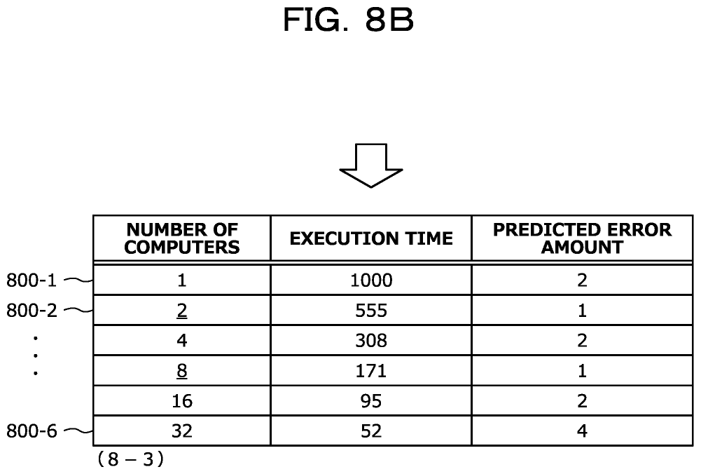

The calculated predicted execution time of the quantum simulation to be executed is, for example, stored in a prediction execution time table 800 as illustrated in FIGS. 8A and 8B, in association with the number of nodes. The prediction execution time table 800 is implemented, for example, by the storage device such as the memory 402 or the disk 404.

FIGS. 8A and 8B are explanatory diagrams illustrating an example of content stored in the prediction execution time table 800. In FIG. 8A, the prediction execution time table 800 includes fields of the number of computers, an execution time, and a predicted error amount and stores predicted execution time information 800-1 to 800-6 as a record, by setting information in each field.

Here, the number of computers is the number of nodes allocated to a quantum simulation (job). The execution time is a predicted execution time required to perform a quantum simulation. The predicted error amount represents a magnitude of an error included in the execution time (predicted execution time). The predicted error amount is used, for example, when the execution time (predicted execution time) is corrected.

In (8-1) in FIG. 8A, an execution time “555” with the number of computers “2” and an execution time “171” with the number of computers “8” are illustrated. The numbers of computers “2, 8” are the numbers of measured computers of which an actual execution time at the time of quantum simulation execution is measured. The execution times “555, 171” of the respective numbers of computers “2, 8” are measured execution times specified from the execution time information. The number of measured computers “2, 8” are underlined.

In (8-2) in FIG. 8A, execution times “1000, 308, 95, 52” of the respective numbers of computers “1, 4, 16, 32” other than the number of measured computers are illustrated. The execution times “1000, 308, 95, 52” of the respective numbers of computers “1, 4, 16, 32” are predicted based on the execution times “555, 171” of the numbers of measured computers “2, 8”.

For example, the calculation unit 703 calculates an improvement degree of a performance when the number of computers is quadrupled, from the execution time “555” of the number of measured computers “2” and the execution time “171” of the number of measured computers “8”. Here, the improvement degree of the performance when the number of computers is quadrupled is, for example, “555/171”.

Next, the calculation unit 703 calculates an improvement degree of a performance when the number of computers is doubled by obtaining a square of the improvement degree “555/171” of the performance when the number of computers is quadrupled. Here, the improvement degree of the performance when the number of computers is doubled is, for example, “(555/171)^{1/2}”.

Then, the calculation unit 703 calculates an execution time of each of the numbers of computers “1, 4, 16, 32”, based on the improvement degree “(555/171)^{1/2}” of the performance when the number of computers is doubled. The execution time of the number of computers “1” is obtained as “1000” by multiplying the execution time “555” of the number of measured computers “2” by “(555/171)^{1/2}”.

The execution time of the number of computers “4” is obtained as “308” by dividing the execution time “555” of the number of measured computers “2” by “(555/171)^{1/2}”. The execution time of the number of computers “16” is obtained as “95” by dividing the execution time “171” of the number of measured computers “8” by “(555/171)^{1/2}”. The execution time of the number of computers “32” is obtained as “52” by dividing the execution time “171” of the number of measured computers “8” by “(555/171)”.

However, the execution time of each of the numbers of computers “1, 4, 16, 32” is an example and is set as the values illustrated in FIGS. 8A and 8B for the sake of description. As a method for predicting an unknown execution time (execution time of each of numbers of computers “1, 4, 16, 32”) from a known execution time (execution times of respective numbers of measured computers “2, 8”), any existing method may be used.

Returning to the description of FIG. 7, the calculation unit 703 may calculate a predicted error amount regarding the calculated predicted execution time of the quantum simulation to be executed. Here, the predicted error amount represents a magnitude of an error included in the calculated predicted execution time. The error is an error of the predicted execution time with respect to an actual execution time.

Here, it is assumed that, as a difference between the number of nodes corresponding to the predicted execution time of the quantum simulation to be executed and the number of measured computers is larger, the error included in the predicted execution time is larger. Therefore, for example, the calculation unit 703 may calculate a distance between the number of nodes corresponding to the predicted execution time of the quantum simulation to be executed and the number of nodes (the number of measured computers) corresponding to the measured execution time used to calculate the predicted execution time as the predicted error amount.

Here, a calculation example of the predicted error amount will be described with reference to FIGS. 8A and 8B.

In the example in FIG. 8A, the number of measured computers is the numbers of computers “2, 8”. In this case, for example, the calculation unit 703 sets a predicted error amount corresponding to the numbers of computers “2, 8” as “1”.

Next, the calculation unit 703 calculates a distance between each number of computers and the number of measured computers, as the predicted error amount corresponding to each of the numbers of computers “1, 4, 16, 32” other than the number of measured computers. When calculating the distance, the calculation unit 703 uses the number of measured computers close to each of the numbers of measured computers “2, 8”.

Furthermore, for example, the distance is represented by a ratio between each number of computers and the number of measured computers. For example, in a case where the number of computers is smaller than the number of measured computers, the distance is represented by “the number of measured computers/the number of computers”. On the other hand, in a case where the number of computers is larger than the number of measured computers, the distance is represented by “the number of computers/the number of measured computers”.

Here, the number of measured computers close to the number of computers “1”, among the numbers of measured computers “2, 8” is “2”. In this case, by dividing the number of measured computers “2” by the number of computers “1”, the calculation unit 703 calculates a predicted error amount “2” corresponding to the number of computers “1”.

Furthermore, the number of measured computers close to the number of computers “4”, among the numbers of measured computers “2, 8” is “2”. In this case, by dividing the number of computers “4” by the number of measured computers “2”, the calculation unit 703 calculates a predicted error amount “2” corresponding to the number of computers “4”.

Furthermore, the number of measured computers close to the number of computers “16”, among the numbers of measured computers “2, 8” is “8”. In this case, by dividing the number of computers “16” by the number of measured computers “8”, the calculation unit 703 calculates a predicted error amount “2” corresponding to the number of computers “16”.

Furthermore, the number of measured computers close to the number of computers “32”, among the number of measured computers “2, 8” is “8”. In this case, by dividing the number of computers “32” by the number of measured computers “8”, the calculation unit 703 calculates a predicted error amount “4” corresponding to the number of computers “32”.

As the value of the predicted error amount is larger, this means that the error included in the predicted execution time is larger. The calculated predicted error amount is stored in the prediction execution time table 800, for example, in association with the number of nodes. In (8-3) in FIG. 8B, the predicted error amounts “2, 1, 2, 1, 2, 4” of the respective numbers of computers “1, 2, 4, 8, 16, 32” are illustrated.

The determination unit 704 determines the number of nodes to be allocated to the quantum simulation to be executed, from the numbers of nodes #1 to #m, based on the calculated predicted execution time, according to the allocation status of the quantum simulation for the group of nodes N1 to Nn. Here, the execution start time of the quantum simulation to be executed is determined, for example, according to an allocation status of another quantum simulation for the numbers of nodes #1 to #m.

Therefore, for example, the determination unit 704 determines the number of nodes to be allocated to the quantum simulation to be executed, so that the execution start time of the quantum simulation to be executed becomes earlier, according to the allocation status of the another quantum simulation for the numbers of nodes #1 to #m. The execution start time of the quantum simulation to be executed can be specified by inquiring the scheduler SC illustrated in FIG. 3, for example.

For example, the determination unit 704 designates the number of nodes #i and the predicted execution time calculated for the number of nodes #i, for each number of nodes #i and inquires the scheduler SC about the execution start time of the quantum simulation to be executed. Then, the determination unit 704 may determine the number of nodes #i with which the execution start time becomes the earliest, among the numbers of nodes #1 to #m, as the number of nodes to be allocated to the quantum simulation to be executed.

For example, the determination unit 704 designates the number of nodes #i and the predicted execution time for the scheduler SC, in ascending order from the small number of nodes #i among the numbers of nodes #1 to #m, and attempts to input a job (quantum simulation to be executed). Therefore, in a case of acquiring the execution start time of the job from the scheduler SC, the determination unit 704 cancels the job.

In this way, by repeating “input the job→acquire the execution start time→cancel the job” in ascending order from the small number of nodes #i of the numbers of nodes #1 to #m, the execution start time is acquired for each number of nodes #i. Then, the determination unit 704 may determine the number of nodes #i with which the execution start time becomes the earliest, among the numbers of nodes #1 to #m, as the number of nodes to be allocated to the quantum simulation to be executed.

Note that, when the input of the job is attempted, there is a case where the job is immediately executed, depending on the allocation status of the another quantum simulation for the numbers of nodes #1 to #m. In this case, the scheduling device 301 sets the current time as the execution start time of the job (quantum simulation to be executed) and determines that the input of the job has been completed.

Furthermore, when acquiring the execution start time for each number of nodes #i, the determination unit 704 may exclude the number of nodes less than the designated number of nodes among the numbers of nodes #1 to #m. The designated number of nodes is, for example, included in the quantum simulation request. For example, the determination unit 704 may designate each number of nodes #i and the predicted execution time, for each number of nodes #i equal to or more than the designated number of nodes, among the numbers of nodes #1 to #m and inquire the scheduler SC about the execution start time of the quantum simulation to be executed.

As a result, the scheduling device 301 cannot secure a memory amount required to execute the job (quantum simulation to be executed) and can prevent an error of the job.

Furthermore, the determination unit 704 may determine the number of nodes #i that makes the execution start time be earlier than that of the designated number of nodes, among the numbers of nodes #1 to #m, as the number of nodes to be allocated to the quantum simulation to be executed. For example, at the time when the number of nodes #i that makes the execution start time be earlier than that of the designated number of nodes is found while the execution start times for the respective numbers of nodes #i are acquired, the determination unit 704 may determine the number of nodes #i as the number of nodes to be allocated to the quantum simulation to be executed.

Furthermore, the scheduling device 301 can acquire the execution start time of the job for each number of nodes #i without inputting the job. For example, the determination unit 704 grasps the allocation statuses of the quantum simulations for the numbers of nodes #1 to #m, for example, in cooperation with the scheduler SC. Then, the determination unit 704 may determine the execution start time of the job by performing scheduling from the number of nodes #i and the predicted execution time of the job (quantum simulation to be executed), according to the allocation statuses of the quantum simulations for the numbers of nodes #1 to #m, similarly to the scheduler SC.

The execution unit 705 allocates the determined number #i of nodes and makes the nodes perform the quantum simulation to be executed. For example, the execution unit 705 designates the determined number #i of nodes and the predicted execution time for the number of nodes #i, for the scheduler SC, and inputs the job (quantum simulation to be executed).

As a result of allocating the determined number #i of nodes and causing the nodes to perform the quantum simulation to be executed, the recording unit 706 stores the measured execution time of the quantum simulation to be executed in the storage unit 710, in association with the determined number #i of nodes and the first quantum circuit.

For example, the recording unit 706 acquires the measured execution time of the job from the scheduler SC, according to completion of the execution of the job (quantum simulation to be executed) for which the number of nodes #i is designated. Then, the recording unit 706 records the acquired measured execution time in the execution time recording table 320, in association with the quantum circuit ID of the first quantum circuit and the number of nodes #i.

For example, it is assumed that the measured execution time “500” be acquired, as a result of designating the number of nodes “4” and performing a quantum simulation using a first quantum circuit with a quantum circuit ID “0x0001”. In this case, the recording unit 706 records the measured execution time “500” in the execution time recording table 320, in association with the quantum circuit ID “0x0001” and the number of nodes “4”. As a result, for example, the execution time information 500-3 as illustrated in FIG. 5 is stored as a new record.

Furthermore, as a result of allocating the determined number #i of nodes and causing the nodes to perform the quantum simulation to be executed, the recording unit 706 may store an error coefficient regarding the first quantum circuit in the storage unit 710, in association with the determined number #i of nodes and the first quantum circuit. Here, the error coefficient includes a first coefficient and a second coefficient.

The first coefficient represents an error between a measured execution time in a case where the first number of nodes are allocated and a predicted execution time in a case where the first number of nodes are allocated, for the quantum simulation using the first quantum circuit. The predicted execution time in a case where the first number of nodes are allocated is an execution time predicted using a measured execution time in a case where the second number of nodes different from the first number of nodes are allocated.

The first coefficient corresponds to a deviation amount between the predicted execution time and the measured execution time. The second coefficient represents an error between the first number of nodes and the second number of nodes. The first coefficient can be calculated, for example, by using the following formula (1). The second coefficient corresponds to the predicted error amount.

first coefficient=|predicted execution time/measured execution time−1| (1)

As an example, a measured execution time in a case where the first number of nodes “8” is allocated to the quantum simulation using the quantum circuit with the quantum circuit ID “0x0000” is set to “180”, and a predicted execution time in a case where the first number of nodes “8” is allocated is set to “216”. Furthermore, the predicted execution time “216” is set as an execution time predicted using a measured execution time in a case where the second number of nodes “4” are allocated. The predicted execution time is specified, for example, from the prediction execution time table 800.

In this case, the recording unit 706 can calculate the first coefficient “0.2” from the predicted execution time “216” and the measured execution time “180”, for example, using the above formula “1”. Furthermore, the second coefficient is, for example, a value “2” obtained by dividing the first number of nodes “8” by the second number of nodes “4”. The second coefficient (predicted error amount) is specified, for example, from the prediction execution time table 800 as illustrated in FIG. 8B.

Then, the recording unit 706 records the first coefficient “0.2” and the second coefficient “2” in the execution time recording table 320, in association with the quantum circuit ID “0x0000” and the number of nodes “8”. The first coefficient “0.2” corresponds to the measured processing time error. The second coefficient “2” corresponds to the predicted error amount. As a result, for example, the execution time information 500-2 as illustrated in FIG. 5 is stored as a new record.

The execution time information 500-2 is used to calculate or correct the predicted execution time of the quantum simulation using the quantum circuit with the quantum circuit ID “0x0000”, for example. Furthermore, for example, the execution time information 500-2 is used to calculate or correct a predicted execution time of a quantum simulation using a quantum circuit of which a feature amount regarding communication is similar to the quantum circuit with the quantum circuit ID “0x0000”.

Furthermore, the calculation unit 703 may correct the calculated predicted execution time of the quantum simulation to be executed. First, a case is assumed where the predicted execution time of the quantum simulation to be executed is calculated based on the measured execution time for each number of nodes allocated to the quantum simulation in the past using the second quantum circuit of which the feature amount is similar to the first quantum circuit.

In this case, the calculation unit 703 corrects the predicted execution time of the quantum simulation to be executed, based on the error coefficient regarding the second quantum circuit stored in the storage unit 710. For example, the calculation unit 703 corrects the predicted execution time, using the error coefficient included in the execution time information corresponding to the quantum circuit ID of the second quantum circuit.

Furthermore, the calculation unit 703 may correct the calculated predicted execution time of the quantum simulation to be executed, based on an error between the feature amounts regarding the communication of the first quantum circuit and the second quantum circuit. For example, the predicted execution time may be corrected to be larger, according to a magnitude of the error of the feature amount.

For example, the calculation unit 703 may preset a coefficient (value equal to or more than one) according to the magnitude of the error of the feature amount. Then, the calculation unit 703 may correct the predicted execution time, by multiplying a coefficient corresponding to the error between the feature amounts regarding the communication of the first quantum circuit and the second quantum circuit by the predicted execution time.

Next, a case is assumed where the predicted execution time of the quantum simulation to be executed is calculated based on the measured execution time for each number of nodes allocated to the quantum simulation in the past using the first quantum circuit. In this case, the calculation unit 703 corrects the predicted execution time of the quantum simulation to be executed, based on the error coefficient regarding the first quantum circuit stored in the storage unit 710. For example, the calculation unit 703 corrects the predicted execution time, using the error coefficient included in the execution time information corresponding to the quantum circuit ID of the first quantum circuit.

Note that a correction example of the predicted execution time of the quantum simulation to be executed will be described later.

Furthermore, the determination unit 704 may determine the number of nodes to be allocated to the quantum simulation to be executed, from among the numbers of nodes #1 to #m, based on the corrected predicted execution time, according to the allocation status of the quantum simulation for the group of nodes N1 to Nn.

(Correction Example of Predicted Execution Time of Quantum Simulation to Be Executed)

Next, the correction example of the predicted execution time of the quantum simulation to be executed will be described.

Here, a case is assumed where a predicted execution time of a quantum simulation to be executed is corrected, using an error coefficient included in execution time information corresponding to the quantum circuit ID “0x0000” in the execution time recording table 320. The quantum simulation to be executed is a quantum simulation using the quantum circuit (first quantum circuit) with the quantum circuit ID “0x0000” or a quantum simulation using the quantum circuit (first quantum circuit) of which the feature amount is similar to the quantum circuit (second quantum circuit) with the quantum circuit ID “0x0000”.

First, the calculation unit 703 specifies error coefficients (N, d) included in the execution time information corresponding to the quantum circuit ID “0x0000” in the execution time recording table 320. Here, N corresponds to a predicted error (second coefficient). The reference d corresponds to a measured processing time error (first coefficient). Next, the calculation unit 703 calculates “D=d/N” from the specified error coefficients (N, d).

Furthermore, there is a case where a plurality of pieces of execution time information corresponding to the quantum circuit ID “0x0000” exists and the plurality of error coefficients (N, d) is specified. In this case, the calculation unit 703 obtains an average value of “d/N” from the plurality of specified error coefficients (N, d) and sets the value as D.

Here, a case is assumed where error coefficients (2, 0.2) included in the execution time information 500-2 corresponding to the quantum circuit ID “0x0000” in the execution time recording table 320 are specified. In this case, the calculation unit 703 calculates “D=0.2/2=0.1” from the error coefficients (2, 0.2).

Here, the number of nodes #i to be allocated to the quantum simulation to be executed is set as “the number of nodes X”. Furthermore, the number of measured computers is set as a “node Y”. However, the number of measured computers is the number of measured computers closest to the number of nodes X.

In this case, in a case of “X>Y”, the calculation unit 703 calculates a margin rate α, for example, using the following formula (2). Furthermore, in a case of “X<Y”, the calculation unit 703 calculates the margin rate α, for example, using the following formula (3). The margin rate α is a coefficient to be multiplied with the predicted execution time for correction.

a=(X/Y)*D+1 (2)

a=(Y/X)*D+1 (3)

Note that, for example, the calculation unit 703 does not need to correct the predicted execution time of the number of nodes #i that is the same as the number of measured computers, among the numbers of nodes #1 to #m.

Then, the calculation unit 703 corrects the predicted execution time by multiplying the predicted execution time for the calculated number of nodes X by the margin rate a. For example, D is set to “D=0.1”, the number of nodes X is set to “X=8”, and the number of nodes Y is set to “Y=4”. Furthermore, a predicted execution time for the number of nodes X is set to “300 [seconds]”.

In this case, the calculation unit 703 calculates the margin rate α using the above formula (2). Here, the margin rate a is “a=1.2”. Then, the calculation unit 703 corrects the predicted execution time by multiplying the predicted execution time by the calculated margin rate “1.2”. Here, the predicted execution time is “360 [seconds]”.

However, there is a case where the error coefficient included in the execution time information corresponding to the quantum circuit ID “0x0000” is not specified from the execution time recording table 320. For example, if a measured value (measured execution time) is not obtained as a result of designating the predicted execution time and executing the job for the number of nodes #i, the error coefficient is kept to be “N/A”.

In this case, the calculation unit 703 may correct the predicted execution time, by multiplying the predicted execution time for the number of nodes X by a margin rate β The margin rate β is a preset coefficient. The margin rate β is a value larger than one. For example, the margin rate β is set to “β=1.1”, and the predicted execution time for the number of nodes X is set to “300 [seconds]”. The calculation unit 703 corrects the predicted execution time by multiplying the predicted execution time by the margin rate “1.1”. Here, the predicted execution time is “330 [seconds]”.

Furthermore, in the above formulas (2) and (3), the predicted execution time is corrected in consideration of both of the error coefficients (N, d). However, the embodiment is not limited to this. For example, the calculation unit 703 may correct the predicted execution time according to only N (predicted error). Furthermore, the calculation unit 703 may correct the predicted execution time according to only d (measured processing time error).

For example, in a case where N (predicted error) is equal to or more than a predetermined threshold, the calculation unit 703 may correct the predicted execution time, by multiplying the predicted execution time for the number of nodes X by the margin rate β. Furthermore, in a case where d (measured processing time error) is equal to or more than a predetermined threshold, the calculation unit 703 may correct the predicted execution time by multiplying the predicted execution time for the number of nodes X by the margin rate β.

(Node Allocation Processing Procedure at The Time of Quantum Simulation Execution of Scheduling Device 301)

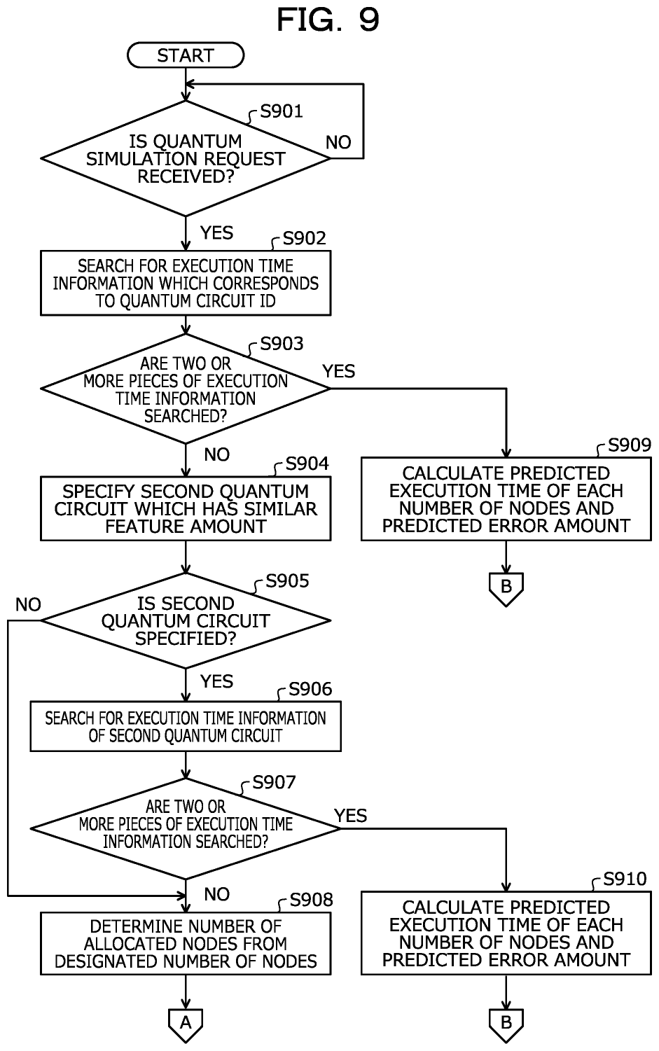

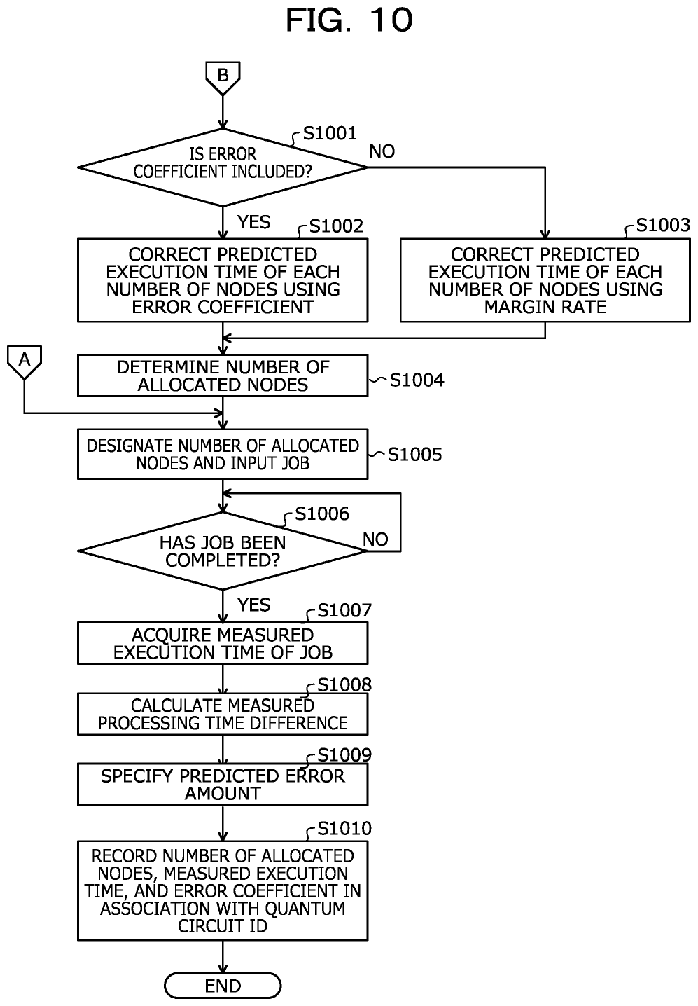

Next, a node allocation processing procedure at the time of quantum simulation execution of the scheduling device 301 will be described with reference to FIGS. 9 and 10.

FIGS. 9 and 10 are flowcharts illustrating an example of the node allocation processing procedure at the time of quantum simulation execution of the scheduling device 301. In the flowchart in FIG. 9, first, the scheduling device 301 determines whether or not a quantum simulation request is received (step S901).

Here, the scheduling device 301 waits for the reception of the quantum simulation request (step S901: No). In a case of receiving the quantum simulation request (step S901: Yes), the scheduling device 301 searches for execution time information corresponding to a quantum circuit ID of a first quantum circuit included in the quantum simulation request from the execution time recording table 320 (step S902). The first quantum circuit is a quantum circuit used for a quantum simulation to be executed.

Then, the scheduling device 301 determines whether or not two or more pieces of execution time information are searched (step S903). Here, in a case where the two or more pieces of execution time information are not searched (step S903: No), the scheduling device 301 refers to the circuit feature amount table 330 and specifies a second quantum circuit of which a feature amount regarding communication is similar to the first quantum circuit (step S904).

Then, the scheduling device 301 determines whether or not the second quantum circuit is specified (step S905). Here, in a case where the second quantum circuit is not specified (step S905: No), the scheduling device 301 proceeds to step S908.

On the other hand, in a case where the second quantum circuit is specified (step S905: Yes), the scheduling device 301 searches for execution time information corresponding to a quantum circuit ID of the searched second quantum circuit from the execution time recording table 320 (step S906).

Then, the scheduling device 301 determines whether or not the two or more pieces of execution time information are searched (step S907). Here, in a case where the two or more pieces of execution time information are not searched (step S907: No), the scheduling device 301 determines the number of allocated nodes of the quantum simulation to be executed from the designated number of nodes included in the quantum simulation request (step S908) and proceeds to step S1005 illustrated in FIG. 10.

The number of allocated nodes is the number of nodes to be allocated to the quantum simulation to be executed. For example, in a case of first execution of the quantum simulation using the first quantum circuit, the scheduling device 301 determines the designated number of nodes as the number of allocated nodes. Furthermore, in a case of second execution of the quantum simulation using the first quantum circuit, the scheduling device 301 determines the number of nodes obtained by doubling the designated number of nodes, as the number of allocated nodes.

Furthermore, in step S903, in a case where the two or more pieces of execution time information are searched (step S903: Yes), the scheduling device 301 calculates a predicted execution time and a predicted error amount regarding the predicted execution time of each number of nodes #i, based on the number of used computers and the execution time of each piece of the acquired execution time information (step S909) and proceeds to step S1001 illustrated in FIG. 10.

The predicted execution time is a predicted value of the execution time of the quantum simulation to be executed in a case where each number of nodes #i are allocated. The calculated predicted execution time and the calculated predicted error amount of each number of nodes #i are stored, for example, in the prediction execution time table 800 illustrated in FIGS. 8A and 8B.

Furthermore, in step S907, in a case where the two or more pieces of execution time information are searched (step S907: Yes), the scheduling device 301 calculates a predicted execution time and a predicted error amount regarding the predicted execution time of each number of nodes #i, based on the number of used computers and the execution time of each piece of the acquired execution time information (step S910) and proceeds to step S1001 illustrated in FIG. 10. The calculated predicted execution time and the calculated predicted error amount of each number of nodes #i are stored, for example, in the prediction execution time table 800.

In the flowchart in FIG. 10, first, the scheduling device 301 determines whether or not an error coefficient is included in the execution time information searched in step S902 or S906 (step S1001). Here, in a case where the error coefficient is included (step S1001: Yes), the scheduling device 301 corrects the predicted execution time of each number of nodes #i using the error coefficient included in the execution time information (step S1002) and proceeds to step S1004.

On the other hand, in a case where the error coefficient is not included (step S1001: No), the scheduling device 301 corrects the predicted execution time of each number of nodes #i, using the preset margin rate β (step S1003). Then, the scheduling device 301 determines the number of allocated nodes so that the execution start time of the quantum simulation to be executed becomes earlier, from among the numbers of nodes #1 to #m, based on the corrected predicted execution time of each number of nodes #i (step S1004). For example, the scheduling device 301 determines the number of nodes #i with which the execution start time becomes the earliest, from among the numbers of nodes #1 to #m, as the number of allocated nodes.

Next, the scheduling device 301 designates the determined number of allocated nodes and the corrected predicted execution time for the number of allocated nodes, with respect to the scheduler SC and inputs the job (quantum simulation to be executed) (step S1005). At this time, the scheduling device 301 designates the corrected predicted execution time for the determined number of allocated nodes. Furthermore, in a case where the procedure proceeds from step S908 illustrated in FIG. 9, for example, the scheduling device 301 may designate the designated predicted execution time included in the quantum simulation request as the predicted execution time. Furthermore, in a case where the procedure proceeds from step S908 illustrated in FIG. 9, the scheduling device 301 may designate a predetermined predicted execution time.

Then, the scheduling device 301 determines whether or not the input job is completed (step S1006). Here, the scheduling device 301 waits for the completion of the input job (step S1006: No). In a case where the input job is completed (step S1006: Yes), the scheduling device 301 acquires a measured execution time of the job from the scheduler SC (step S1007).

Next, the scheduling device 301 refers to the prediction execution time table 800 and calculates a measured processing time error (first coefficient) corresponding to the number of allocated nodes for the first quantum circuit, based on the acquired measured execution time (step S1008). Next, the scheduling device 301 refers to the prediction execution time table 800 and specifies a predicted error amount (second coefficient) corresponding to the number of allocated nodes for the first quantum circuit (step S1009).

Then, the scheduling device 301 records the number of allocated nodes, the measured execution time, and the error coefficient (measured processing time error, predicted error amount) in the execution time recording table 320, in association with the quantum circuit ID of the first quantum circuit (step S1010) and ends the series of processing according to this flowchart. Note that the number of allocated nodes corresponds to the number of used computers in the execution time recording table 320. The measured execution time corresponds to the execution time in the execution time recording table 320.

As a result, the scheduling device 301 can predict scalability characteristics (corresponding to predicted execution time for each number of nodes) of the job (quantum simulation to be executed), determine the number of allocated nodes so as to make the execution start time be earlier, and input the job.

As described above, according to the scheduling device 301 according to the embodiment, it is possible to refer to the storage unit 710 (for example, circuit feature amount table 330) and specify the second quantum circuit of which the feature amount regarding the communication is similar to the first quantum circuit used for the quantum simulation to be executed. The feature amount regarding the communication of the quantum circuit represents, for example, a communication amount between nodes required to perform a quantum simulation.

As a result, the scheduling device 301 can specify the second quantum circuit having the scalability characteristics similar to the first quantum circuit used for the quantum simulation to be executed.

Furthermore, according to the scheduling device 301, it is possible to refer to the storage unit 710 (for example, execution time recording table 320) that stores the measured execution time for each number of nodes allocated to the quantum simulation in the past using the second quantum circuit and calculate the predicted execution time of the quantum simulation to be executed in a case where each number of nodes #i are allocated, for each number of nodes #i of the numbers of nodes #1 to #m. Then, according to the scheduling device 301, it is possible to determine the number of allocated nodes of the quantum simulation to be executed, from among the numbers of nodes #1 to #m, based on the calculated predicted execution time, according to the allocation status of the quantum simulation for the group of nodes N1 to Nn. Furthermore, according to the scheduling device 301, it is possible to allocate the determined number of allocated nodes and make the nodes perform the quantum simulation to be executed.

As a result, the scheduling device 301 can predict the scalability characteristics of the quantum simulation to be executed, using that scalability in parallel execution of the quantum simulation depends on the configuration of the quantum circuit. Furthermore, even in a case where there is no record of the quantum simulation using the first quantum circuit, the scheduling device 301 can predict the scalability characteristics of the quantum simulation to be executed, using the record of the quantum simulation using the second quantum circuit having the scalability characteristics similar to the first quantum circuit. Furthermore, according to the scheduling device 301, it is possible to determine the number of allocated nodes so as to make the execution start time of the quantum simulation to be executed be earlier, based on the predicted scalability characteristics. As a result, the scheduling device 301 can increase the back fill rate and improve the utilization efficiency of the group of nodes N1 to Nn at the time of quantum simulation execution.

Furthermore, according to the scheduling device 301, it is possible to determine the number of nodes with which the execution start time of the quantum simulation to be executed becomes the earliest, among the numbers of nodes #1 to #m, as the number of allocated nodes, based on the calculated predicted execution time, according to the allocation status of the quantum simulation for the group of nodes N1 to Nn.

As a result, the scheduling device 301 can improve the utilization efficiency of the group of nodes N1 to Nn at the time of quantum simulation execution and shorten a time before the execution of the quantum simulation to be executed is completed.

Furthermore, according to the scheduling device 301, it is possible to correct the calculated predicted execution time based on the error coefficient regarding the second quantum circuit stored in the storage unit 710 and to determine the number of allocated nodes so as to make the execution start time of the quantum simulation to be executed be earlier, from among the numbers of nodes #1 to #m, based on the corrected predicted execution time. The error coefficient includes the measured processing time error (first coefficient) and the predicted error amount (second coefficient).

As a result, the scheduling device 301 can improve prediction accuracy of the execution time of the quantum simulation, in consideration of an error from the actual measurement value at the time of past prediction (prediction accuracy). For example, the scheduling device 301 can prevent to force to end the processing in the middle due to a predicted execution time that is too short, by performing correction to increase the predicted execution time according to the prediction accuracy. At this time, the scheduling device 301 can prevent the predicted execution time from being too long, by determining an increment of the predicted execution time according to the prediction accuracy.

Furthermore, according to the scheduling device 301, it is possible to correct the calculated predicted execution time based on the error between the feature amounts regarding the communication of the first quantum circuit and the second quantum circuit and to determine the number of allocated nodes so as to make the execution start time of the quantum simulation to be executed be earlier, from among the numbers of nodes #1 to #m, based on the corrected predicted execution time.

As a result, the scheduling device 301 can improve the prediction accuracy of the execution time of the quantum simulation, in consideration of the magnitude of the error of the feature amounts regarding the communication between the quantum circuits. For example, by correcting the predicted execution time to be longer as the error of the feature amount is larger, the scheduling device 301 can prevent to force to end the processing in the middle due to the predicted execution time that is too short.

Furthermore, according to the scheduling device 301, it is possible to determine whether or not the measured execution time for each number of nodes allocated to the quantum simulation in the past using the first quantum circuit is stored in the storage unit 710. Then, according to the scheduling device 301, in a case where the measured execution time for each number of nodes allocated to the quantum simulation in the past is stored, it is possible to calculate the predicted execution time of the quantum simulation to be executed in a case where each number of nodes #i are allocated, based on the measured execution time for each number of nodes stored in the storage unit 710.

As a result, in a case where there is the record of the quantum simulation in the past using the quantum circuit (first quantum circuit) same as the quantum simulation to be executed, the scheduling device 301 can calculate the predicted execution time of the quantum simulation to be executed using the record.

Furthermore, according to the scheduling device 301, as a result of allocating the determined number of allocated nodes and causing the nodes to perform the quantum simulation to be executed, it is possible to store the determined number of allocated nodes and the measured execution time of the quantum simulation to be executed in the storage unit 710 (for example, execution time recording table 320), in association with the first quantum circuit.

As a result, the scheduling device 301 can record the record of the quantum simulation using the first quantum circuit (measured execution time for each number of nodes).

Furthermore, according to the scheduling device 301, it is possible to correct the calculated predicted execution time based on the error coefficient regarding the first quantum circuit stored in the storage unit 710 and to determine the number of allocated nodes so as to make the execution start time of the quantum simulation to be executed be earlier, from among the numbers of nodes #1 to #m, based on the corrected predicted execution time.

As a result, the scheduling device 301 can improve prediction accuracy of the execution time of the quantum simulation, in consideration of an error from the actual measurement value at the time of past prediction (prediction accuracy).

From these, according to the scheduling device 301, when performing the quantum simulation for the group of nodes N1 to Nn, by increasing the back fill rate, it is possible to improve the utilization efficiency of the group of nodes N1 to Nn and shorten the entire processing time.

Note that the node allocation method at the time of quantum simulation execution described in the present embodiment may be implemented by executing a program prepared in advance on a computer such as a personal computer or a workstation. The node allocation program at the time of quantum simulation execution is recorded on a computer-readable recording medium such as a hard disk, a flexible disk, a CD-ROM, a DVD, or a USB memory, and is read from the recording medium to be executed by the computer. Furthermore, the node allocation program at the time of quantum simulation execution may be distributed via a network such as the Internet.

Furthermore, the information processing device 101 (scheduling device 301) described in the present embodiment may also be implemented by a special-purpose integrated circuit (IC) such as a standard cell or a structured application specific integrated circuit (ASIC) or a programmable logic device (PLD) such as a field-programmable gate array (FPGA).

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a node allocation program at the time of quantum simulation execution for causing a computer to execute processing comprising:
specifying a second quantum circuit of which a feature amount regarding communication is similar to a first quantum circuit used for a first quantum simulation, with reference to a first memory that stores a feature amount regarding communication of a quantum circuit, for each quantum circuit used for a quantum simulation;
calculating a predicted execution time of the first quantum simulation in a case where the number of nodes are allocated for each of a plurality of numbers of nodes, with reference to a second memory that stores a measured execution time for each number of nodes allocated to a quantum simulation in the past by using the specified second quantum circuit; and
determining the number of nodes to be allocated to the first quantum simulation, from among the plurality of numbers of nodes, based on the calculated predicted execution time, according to an allocation status of a quantum simulation for a node group that is usable for the first quantum simulation.

2. The non-transitory computer-readable recording medium according to claim 1, wherein
the determining processing
determines the number of nodes with which an execution start time of the first quantum simulation becomes the earliest based on the calculated predicted execution time, from among the plurality of numbers of nodes, as the number of nodes to be allocated to the first quantum simulation.

3. The non-transitory computer-readable recording medium according to claim 1, wherein
the second memory stores an error coefficient regarding the second quantum circuit,
the calculating processing
corrects the calculated predicted execution time based on the error coefficient regarding the second quantum circuit stored in the second memory,
the determining processing
determines the number of nodes to be allocated to the first quantum simulation, from among the plurality of numbers of nodes, based on the corrected predicted execution time, and
the error coefficient includes a first coefficient that represents an error between a measured execution time in a case where a first number of nodes are allocated and a predicted execution time in a case where the first number of nodes are allocated, which is predicted by using a measured execution time in a case where a second number of nodes different from the first number of nodes are allocated, and a second coefficient that represents an error between the first number of nodes and the second number of nodes, for a quantum simulation by using the second quantum circuit.

4. The non-transitory computer-readable recording medium according to claim 1, wherein
the calculating processing
corrects the calculated predicted execution time, based on an error between feature amounts regarding communication of the first quantum circuit and the second quantum circuit, and
the determining processing
determines the number of nodes to be allocated to the first quantum simulation, from among the plurality of numbers of nodes, based on the corrected predicted execution time.

5. The non-transitory computer-readable recording medium according to claim 1, wherein the feature amount regarding communication of the quantum circuit represents a communication amount between nodes required to perform the quantum simulation.

6. The non-transitory computer-readable recording medium according to claim 1, for causing the computer to execute processing comprising: allocating the determined number of nodes and making the nodes perform the first quantum simulation.

7. The non-transitory computer-readable recording medium according to claim 1, for causing the computer to execute processing comprising:
determining whether or not a measured execution time for each number of nodes allocated to a quantum simulation in the past by using the first quantum circuit is stored in the second memory, wherein
the calculation processing
calculates a predicted execution time of the first quantum simulation in a case where the number of nodes are allocated for each of the plurality of numbers of nodes, based on the measured execution time for each number of nodes stored in the second memory, in a case where the measured execution time for each number of nodes allocated to the quantum simulation in the past is stored.

8. The non-transitory computer-readable recording medium according to claim 7, for causing the computer to execute processing comprising: storing the determined number of nodes and the measured execution time of the first quantum simulation in the second memory, in association with the first quantum circuit, as a result of allocating the determined number of nodes and making the nodes perform the first quantum simulation.

9. The non-transitory computer-readable recording medium according to claim 8, wherein
the second memory stores an error coefficient regarding the first quantum circuit,
the calculating processing
corrects the calculated predicted execution time based on the error coefficient regarding the first quantum circuit stored in the second memory,
the determining processing
determines the number of nodes to be allocated to the first quantum simulation, from among the plurality of numbers of nodes, based on the corrected predicted execution time, and
the error coefficient includes a first coefficient that represents an error between a measured execution time in a case where the first number of nodes are allocated and a predicted execution time in a case where the first number of nodes are allocated, which is predicted by using a measured execution time in a case where the second number of nodes different from the first number of nodes are allocated, and a second coefficient that represents an error between the first number of nodes and the second number of nodes, for a quantum simulation by using the first quantum circuit.

10. A node allocation method at the time of quantum simulation execution comprising:
specifying a second quantum circuit of which a feature amount regarding communication is similar to a first quantum circuit used for a first quantum simulation, with reference to a first memory that stores a feature amount regarding communication of a quantum circuit, for each quantum circuit used for a quantum simulation;
calculating a predicted execution time of the first quantum simulation in a case where the number of nodes are allocated for each of a plurality of numbers of nodes, with reference to a second memory that stores a measured execution time for each number of nodes allocated to a quantum simulation in the past by using the specified second quantum circuit; and
determining the number of nodes to be allocated to the first quantum simulation, from among the plurality of numbers of nodes, based on the calculated predicted execution time, according to an allocation status of a quantum simulation for a node group that is usable for the first quantum simulation.

11. An information processing device comprising:
a first memory;
a second memory; and
a processor coupled to the first memory and the second memory and configured to:
specify a second quantum circuit of which a feature amount regarding communication is similar to a first quantum circuit used for a first quantum simulation, with reference to the first memory that stores a feature amount regarding communication of a quantum circuit, for each quantum circuit used for a quantum simulation;
calculate a predicted execution time of the first quantum simulation in a case where the number of nodes are allocated for each of a plurality of numbers of nodes, with reference to the second memory that stores a measured execution time for each number of nodes allocated to a quantum simulation in the past by using the specified second quantum circuit; and
determine the number of nodes to be allocated to the first quantum simulation, from among the plurality of numbers of nodes, based on the calculated predicted execution time, according to an allocation status of a quantum simulation for a node group that is usable for the first quantum simulation.
